(19) United States
(12) Patent Application Publication
(10) Pub. No.: US 2026/0042656 A1
(43) Pub. Date: Feb. 12, 2026

(54) BEVERAGE STORAGE AND DISPENSING SYSTEM

(71) Applicant: OASES INNOVATIONS CORPORATION, Scottsdale, AZ (US)

(72) Inventor: Connor David KUDIRKA, San Bernardino, CA (US)

(73) Assignee: OASES INNOVATIONS CORPORATION, Scottsdale, AZ (US)

(21) Appl. No.: 19/293,970

(22) Filed: Aug. 7, 2025

Related U.S. Application Data
(60) Provisional application No. 63/680,530, filed on Aug. 7, 2024.
(60) Provisional application No. 63/721,538, filed on Nov. 17, 2024.

(51) Int. Cl. B67D 1/08; B67D 1/04; B67D 1/12

(52) U.S. Cl. CPC B67D 1/0804; B67D 1/0406; B67D 1/1277; B67D 2001/0824

(57) ABSTRACT

A beverage storage container is provided. The beverage storage container including: a beverage chamber; a gas chamber disposed within the beverage chamber; a dispenser; and a selector, wherein the selector is movable between two positions: (1) an off position wherein the dispenser, the gas chamber, and the beverage chamber are isolated from each other and (2) a dispense position wherein the dispenser, the gas chamber, and the beverage chamber are each in fluid communication with each other.

### RELATED APPLICATIONS

The present patent application relates to U.S. Provisional Patent Application Ser. Nos. 63/680,530, filed Aug. 7, 2024, and 63/721,538, filed Nov. 26, 2024 which are incorporated herein by reference in their entirety.

### FIELD

This patent application relates, in general, to the field of beverage storage and dispensing systems.

### BACKGROUND

Systems and methods for storing and dispensing beverages from multiple containers are known. These systems commonly require a network of external taps, tubing, and manifolds to connect multiple beverage containers and pressurized gas containers. These systems often increase in complexity as the number of containers increases.

### SUMMARY

In one embodiment, a beverage storage container is provided. The beverage storage container including: a beverage chamber; a gas chamber disposed within the beverage chamber; a dispenser; and a selector, wherein the selector is movable between three positions: (1) an off position wherein the dispenser, the gas chamber, and the beverage chamber are isolated from each other, (2) a purge position wherein the dispenser and the gas chamber are in fluid communication with each other and the beverage chamber is isolated from the dispenser and the gas chamber, and (3) a dispense position wherein the dispenser, the gas chamber, and the beverage chamber are each in fluid communication with each other.

Implementations of the foregoing aspects may include one or more of the following features.

In some embodiments, the gas chamber includes a regulator configured to restrict an outflow of gas from the gas chamber at a set pressure. The set pressure may be between 8-25 psi. The selector may include a slide valve. The beverage container may include blocker configured to prevent fluid communication, wherein the dispenser is disposed above the blocker in the off position. The beverage container may further include a spear configured to guide fluid to the dispenser, wherein the dispenser and spear are disposed in an offset relationship to one another when the selector is in the off position and the purge position. The gas chamber may be configured to store between 5-100 ounces of CO2. The gas chamber may be configured to store between 10-100 grams of CO2. The selector may be configured to allow gas to flow from the gas chamber and increase head pressure in the beverage chamber when the selector is in the dispense position. The selector may be configured to allow gas to flow from the gas chamber through the dispenser and out of the beverage storage container when the selector is in the purge position.

In one embodiment, a beverage storage system is provided. including: a first beverage storage container; and a second beverage storage container, wherein the first and second beverage storage containers each include: a pressurized beverage chamber; at least two cross container connectors; and a dispensing connector, wherein: the first and second beverage storage containers are configured to connect to each other, one of the at least two cross container connectors of the first beverage storage container is fluid communication with one of the at least two cross container connectors of the second beverage storage container, and the pressurized beverage chamber of the first beverage storage container is substantially pressure balanced with the pressurized beverage chamber of the second beverage storage container when the first and second beverage storage containers are connected.

Implementations of the foregoing aspects may include one or more of the following features.

The beverage storage system may include an external dispenser, wherein the external dispenser is configured to dispense a liquid beverage from both the first beverage storage container and the second beverage storage container through the dispensing connector of the first beverage storage container. The at least two cross container connectors may include a male connector and a female connector. The male connector and the female connector may be on a same side of the respective beverage storage container. A connection of the first beverage storage container and the second beverage storage container may include two connection points, wherein at the first connection point, the male connector of the first beverage storage container is in fluid communication with the female connector of the second beverage storage container and at the second connection point, the female connector of the first beverage storage container is in fluid communication with the male connector of the second beverage storage container. The at least two cross container connectors may each include a lock feature, wherein the lock feature is configured to engage with a corresponding lock feature of a cross container connector on another beverage storage container. The at least two cross container connectors may include eight cross container connectors. wherein any one of the beverage storage containers is configured to simultaneously connect to the other two beverage storage containers. The beverage storage system may further include a fourth and fifth beverage storage container, wherein any one of the beverage storage containers is configured to simultaneously connect to the other four beverage storage containers. Each beverage storage container may further include a gas chamber disposed within the pressurized beverage chamber.

In one embodiment, a method for storing and serving a beverage system is provided. The method including the steps of: connecting a first beverage storage container and a second beverage storage container, wherein the first and second beverage storage containers each include a pressurized beverage chamber, at least two cross container connectors, and a dispensing connector, wherein the first and second beverage storage containers are configured to connect to each other, one of the at least two cross container connectors of the first beverage storage container is fluid communication with one of the at least two cross container connectors of the second beverage storage container; balancing the pressurized beverage chamber of the first beverage storage container with the pressurized beverage chamber of the second beverage storage container; and dispensing beverage from both the first and second beverage storage container through the dispensing connector of the first beverage storage container.

Non-limiting advantages of one or more embodiments may include one or more of the following: Increased efficiency and decreased setup and installation time for beverage dispensing systems; convenient packaging for transporting and storage of beverages. These and other advantages and features will be apparent from the description, the drawings, and the claims.

### BRIEF DESCRIPTION OF THE DRAWINGS

The numerous advantages of this patent application may be better understood by those skilled in the art by reference to the accompanying Figures. In the drawings, like reference numerals designate corresponding parts throughout the several views.

FIG. 1 shows a cross-section view of an exemplary beverage storage container in accordance with one or more embodiments, showing the selector in the off position.

FIG. 2 shows a cross-section view of an exemplary beverage storage container in accordance with one or more embodiments, showing the selector in the purge position.

FIG. 3 shows a cross-section view of an exemplary beverage storage container in accordance with one or more embodiments, showing the selector in the dispense position.

FIG. 4 shows a side view of a beverage storage container in accordance with one or more embodiments.

FIG. 5 shows a perspective view of a beverage storage container in accordance with one or more embodiments.

FIG. 6 shows a top view of a beverage storage container in accordance with one or more embodiments.

FIG. 7 shows a perspective view of a beverage storage container in accordance with one or more embodiments.

FIG. 8 shows a bottom view of a beverage storage container.

FIG. 9 shows a side view of a beverage storage system in accordance with one or more embodiments.

FIG. 10 shows a perspective view of the beverage storage system shown in FIG. 9.

FIG. 11 shows a connection diagram of a beverage storage system in accordance with one or more embodiments.

Corresponding reference names and/or numerals indicate corresponding parts throughout the several views of the drawings.

### DETAILED DESCRIPTION

As described above, this patent application provides a beverage storage system 10. The beverage storage system 10 may be interchangeably referred to as a beverage dispensing system 10, and a beverage storage and dispensing system 10. The beverage storage system 10 comprises at least one beverage storage container 110. The beverage storage container 110 may be interchangeably referred to as a storage container 110 and a beverage container 110. The number of beverage storage containers 110 in the beverage storage system 10 may vary in different embodiments.

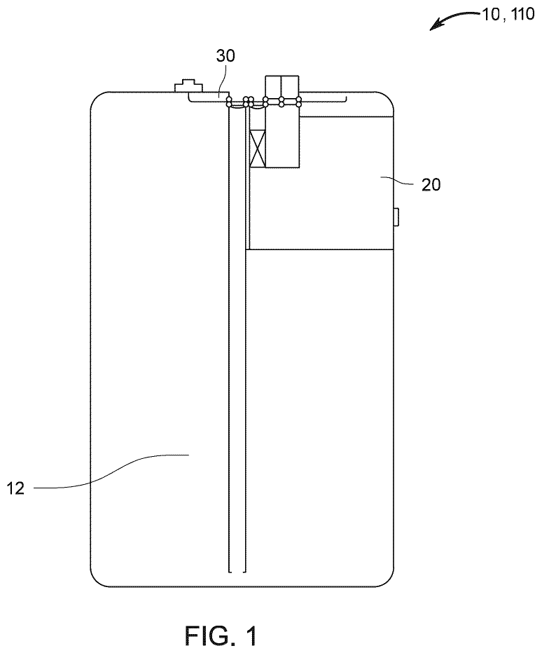

Referring to FIG. 1-3, in some embodiments the beverage storage system 10 comprises a single beverage storage container (e.g., keg, barrel, vessel, tank, etc.) 110. The beverage storage container 110 houses two sealed chambers, a beverage chamber 12 and a gas chamber 20. The gas chamber 20 may be sealed within the beverage storage container 110. For example, the gas chamber may be within the beverage chamber 12 in some embodiments. Specifically, a liquid beverage (e.g., beer, wine, liquor, carbonated non-alcoholic beverages, etc.) stored within the beverage chamber 12 would be permitted to contact the outer walls of the gas chamber 20.

By having two sealed chambers, the beverage storage container 110 is configured to store a liquid beverage (e.g., beer, wine, liquor, carbonated non-alcoholic beverages, etc.) in the beverage chamber 12 and pressurized gas (CO2, nitrogen, etc.) in the gas chamber 20 wherein each chamber has a different pressure. For example, the gas chamber 20 can store CO2 at a higher pressure than the head pressure in the beverage chamber 12 without the CO2 flowing from the gas chamber 20 to the beverage chamber 12 and equalizing the pressure in the two chambers.

In some embodiments, the size of the gas chamber 20 is based on the amount of gas required to serve the contents of the beverage chamber 12 (e.g., a beverage chamber filled to its maximum capacity of beer). The amount of gas required to serve the entire contents of the beverage chamber 12 depends on several factors such as the size of the beverage chamber 12, the carbonation levels of the beverage, and the size of the serving line (e.g., the length and inner diameter of the tube from the keg to the tap). A beverage chamber 12 capable of storing 30 servings (e.g., 12 oz per serving) of beer has a gas chamber 20 sized between 10 and 100 grams of CO2. A beverage chamber 12 capable of storing 120 servings (e.g., 12 oz per serving) of beer has a gas chamber 12 sized between 5 oz and 100 oz of CO2.

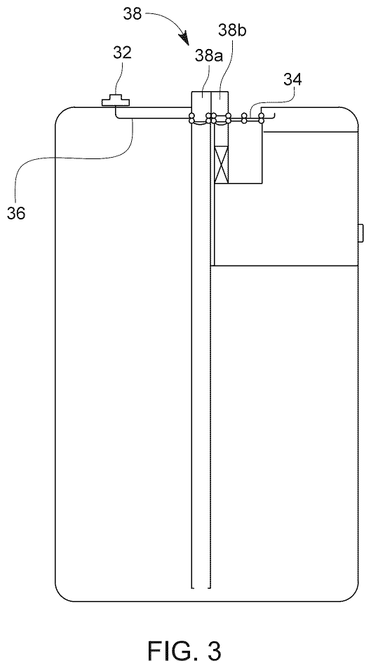

Referring to FIG. 3, to dispense the beverage out of the beverage storage container 110, the beverage storage container 110 is configured to allow fluid communication between the gas chamber 20 and the beverage chamber 12. The beverage storage container 110 comprises a selector 30 which a user can operate to selectively connect the gas chamber 20 to the beverage chamber 12 to allow fluid communication between the two chambers. In some embodiments the gas chamber 20 comprises a regulator 26 configured to restrict the flow of gas from the gas chamber 20 to the beverage chamber 12. The regulator 26 may be disposed in an outlet and only allow gas to flow out of the gas chamber 20 when the pressure on the downstream side (i.e. the side of the pressure regulator 26 opposite the gas chamber 20) drops below a set pressure. In some embodiments, the set pressure of the regulator 26 is fixed (e.g., set by the k value of a spring) and, in other embodiments, the set pressure is adjustable (e.g., tunable by a user).

Referring to FIG. 1, a user can also operate the selector 30 to selectively isolate the gas chamber 20 from the beverage chamber 12. In the off position, the selector 30 disconnects the gas chamber 20 from the beverage chamber 12.

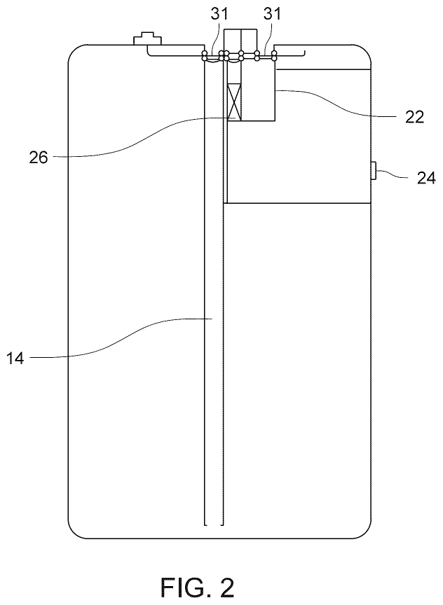

Referring to FIG. 2, the beverage storage container 110 comprises a dispenser 38 and, in some embodiments, a user can operate the selector 30 to purge the dispenser 38 and any downstream serving lines with gas from the gas chamber 20. With the selector 30 in the purge position, the gas chamber 20 and dispenser 38 are in fluid communication.

In some embodiments, the selector 30 comprises a lever 32 and a sliding valve 36. The sliding valve comprises a sealing interface 34 at multiple interface locations 31. The lever 32 may be operated by a user to manipulate the fluid communication between the dispenser 38, the gas chamber 20, and the beverage chamber 12. In an exemplary embodiment, operating the lever 32 moves the dispenser 38 across the sealing interface 34 to different interface locations 31. In the off position, the dispenser 38 is positioned at an interface location 31 above a fluid blocker 22. In the purge position, the dispenser 38 is placed above the outlet from the regulator 26. In the dispense position, the dispenser 38 is placed at an interface location 31 above a beverage pickup tube (e.g., spear 14) disposed in the beverage chamber 12.

In some embodiments, the dispenser 38 comprises a nozzle side 38a and a charge side 38b. the nozzle side 38a of the dispenser 38 includes an outlet from the beverage storage container 110. The nozzle side 38a is typically connected to a serving line, tubing, or some other serving system outside of the beverage storage container 110. The charge side 38b is connected to the beverage chamber.

In an exemplary embodiment, the beverage storage container 110 is configured so that the sealing interface 34 comprises four interface locations 31 which include: two interface locations 31 at the fluid blocker 22, one interface location 31 at the gas chamber 20, and one interface location at the beverage pickup tube (e.g., spear 14). As the dispenser 38 is operated the nozzle side 38a and the charge side 38b each connect at a separate single interface location 31. For example, in the off position, the nozzle side 38a and the charge side 38b are each connected with one of the two interface locations 31 at the fluid blocker 22. In the purge position, the nozzle side 38a is connected with the interface location 31 at the gas chamber 20 and the charge side 38b is connected with an interface location 31 at the fluid blocker 22. In the dispense position, the nozzle side 38a is connected to the interface location 31 at the spear 14 and the charge side 38b is connected to the interface location at the gas chamber 20.

When the selector 30 is in the dispense position, gas is permitted to flow from the gas chamber 20 through the charge side 38a of the dispenser 38 to the beverage chamber 12. The regulator 26 allows pressurized gas to flow from the gas chamber 20 to maintain a set head pressure in the beverage chamber 12 while the beverage is allowed to flow through the spear 14 and out of the nozzle side 38a of the dispenser 38. In some embodiments, the head pressure is set between 5 and 25 psi.

When neither the nozzle side 38a nor the charge side 38b of the dispenser 38, the sealing interface 34 is closed at that interface location. For example, when the selector 30 is in the purge and off positions, the spear 14 is offset from the dispenser 38 (i.e. not directly below any portion of the dispenser 38) and neither side 38a, 38b of the dispenser 38 is connected to the interface location 31 above the spear 14. In the purge and off positions, no beverage is able to escape up the spear 14 and out of the beverage storage container 110 because of this offset relationship between the spear 14 and the nozzle side 38a of the dispenser 38.

In some embodiments the gas chamber 20, dispenser 28, and selector 30 are disposed near the top portion of the beverage storage container 110 and the spear 14 extends to the bottom end of the beverage storage container 110. This configuration reduces complexity by keeping the interacting components close while also allowing the spear 14 to pickup beverage from the bottom portion of the beverage storage container 110. In some embodiments, the spear 14 is rigid and, in other embodiments, the spear 14 is flexible to permit movement of the spear 14 so that it may pickup beverage from the low point of the beverage storage container 110 even in alternative orientations (e.g., when the storage container 110 is laid on its side).

In some embodiments, the gas chamber 20 is fillable/refillable and includes a gas inlet port 24. The gas inlet port 24 is accessible from the outside of the beverage storage container 110 and disposed on the top or side of the beverage storage container 110 for filling/refilling access. In some embodiments, the entire gas chamber 20 is removable from the beverage storage container 110 for servicing, pressure certifying, and/or refilling.

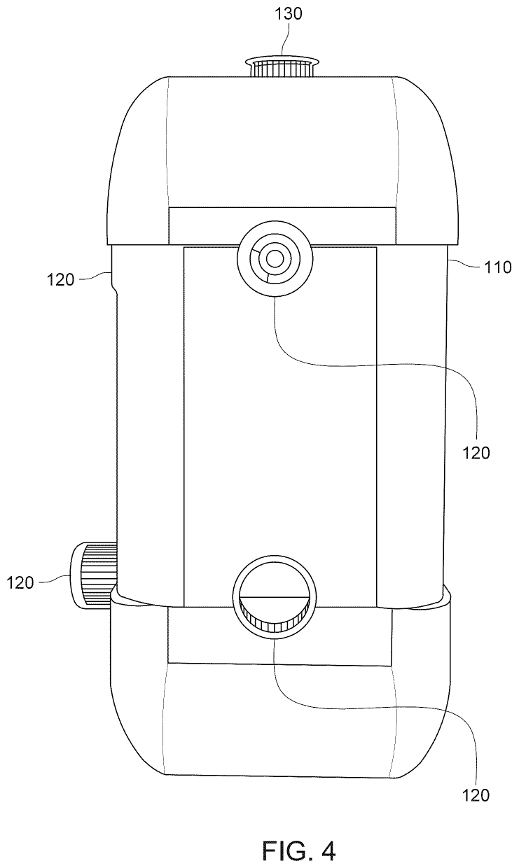

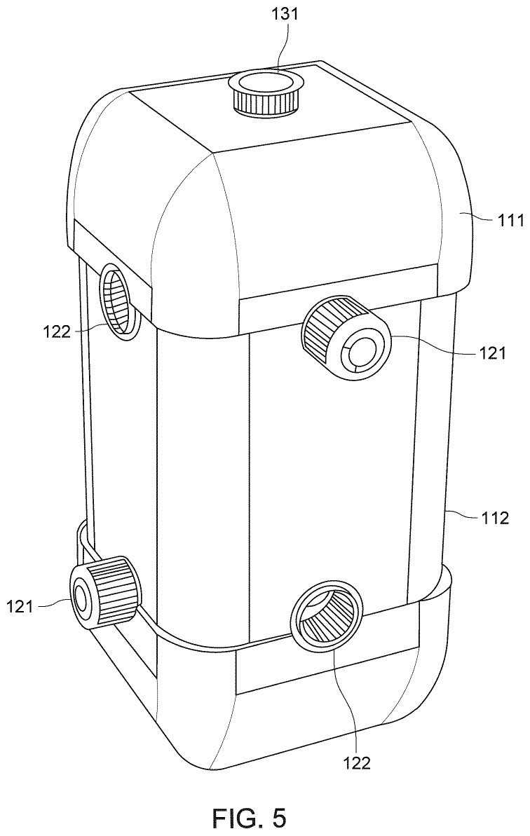

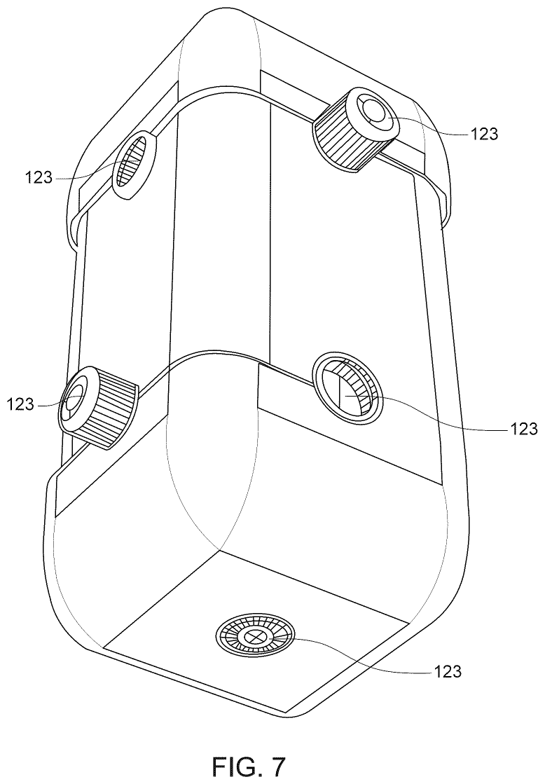

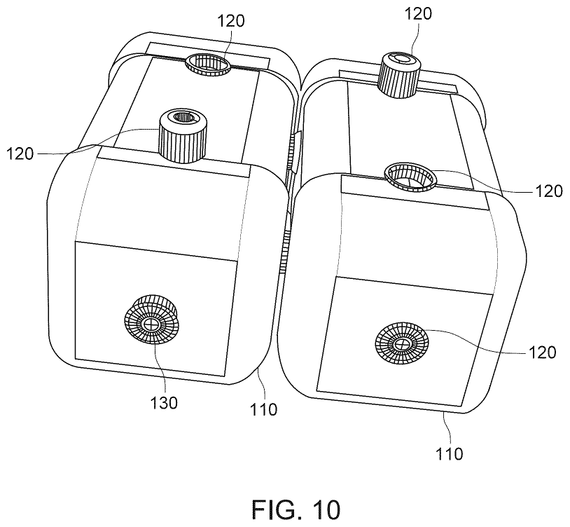

Referring to FIGS. 4-11, the beverage storage system 10 includes cross container connectors 120. The cross container connectors 120 are configured to allow fluid communication between beverage storage containers 110. For example, two beverage storage containers 110 connected by cross container connectors 120 have a gas and liquid balance with each other. Each beverage storage container 110 may include a single cross container connector 120 or a plurality of cross container connectors 120. In some embodiments, the beverage storage containers 110 have a square or rectangular prism-like structure with four side faces, a top face, and a bottom face. The cross container connectors 120 are configured to connect a side face of one storage container 110 to the side face of another storage container 110. In some embodiments, cross container connectors 120 are configured to connect the top face of one beverage storage container 110 to the bottom face of another beverage storage container 110.

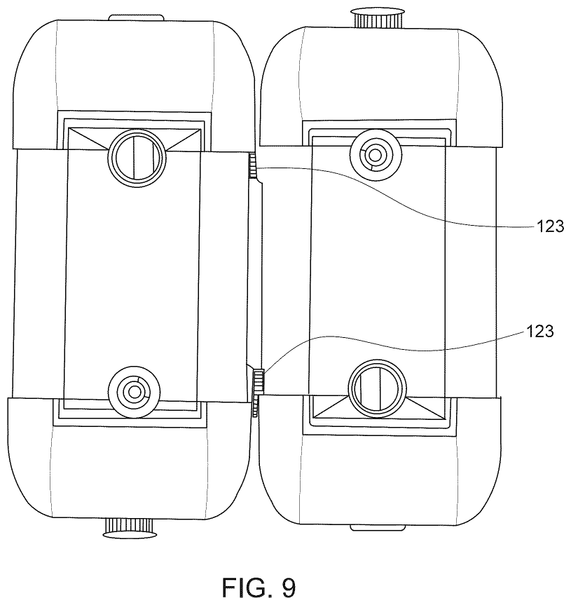

In the illustrated embodiment of FIG. 9, the beverage storage system includes a first beverage storage container 110 and a second beverage storage container 110. The two beverage storage containers 110 are connected at two connection points 123. At each of these connection points 123, the respective cross container connectors 120 from each beverage storage container 110 couple with the cross container connectors 120 from the other beverage storage container 110.

In some embodiments, a connection is made between two beverage storage containers 110 at two connection points 123, a high connection point 123 near the top face of the beverage storage container 110, and a low connection point 123 near the bottom face of beverage storage container 110.

In the illustrated embodiment of FIG. 9, two connected beverage storage containers 110 with connection points 123 on their side face may be connected in opposite orientation to each other (e.g., the bottom face of one storage container 110 is adjacent to the top face of the other storage container 110).

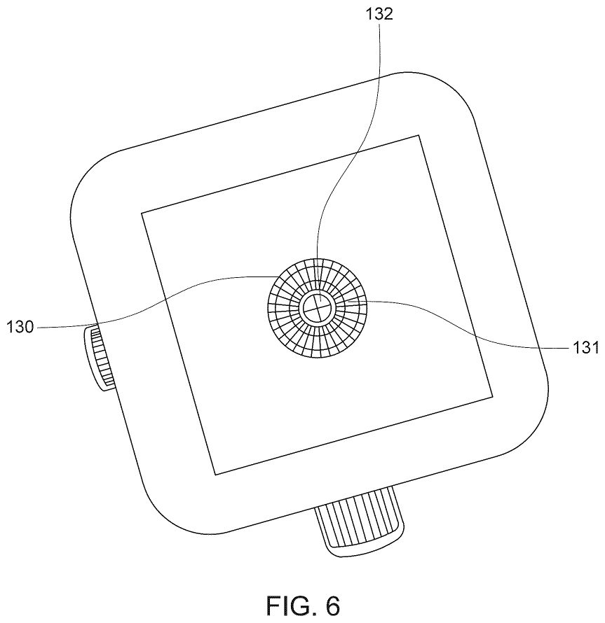

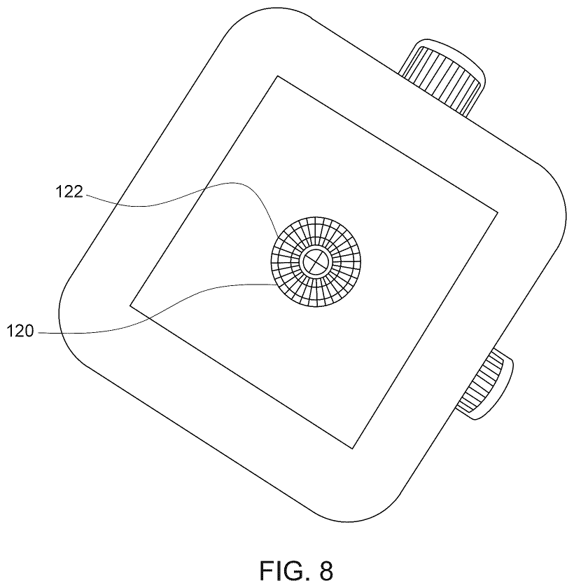

In some embodiments, the cross container connectors 120 include male connectors 121 and female connectors 122. Each side face of a beverage storage container 110 has one male connector 121 and one female connector 122. In other embodiments, such as those illustrated in FIGS. 6 and 8, only two side faces have any cross container connectors 120. A cross container connector 120 may also be included on the top face and the bottom face of a beverage storage container 110. By having cross container connectors 120 on multiple faces of a single beverage storage container 110, one beverage storage container 110 can simultaneously connect directly to multiple beverage storage containers 110. For example, a beverage storage container 110 with a male connector 121 and a female connector 122 on each of its four side faces can simultaneously, directly connect with at least four other beverage storage containers 110 (i.e. one beverage storage container 110 connected to each face). To simultaneously connect multiple beverage storage containers 110 to a single beverage storage container 110, each side may have alternating male connector 121 and female connector 122 positions. As illustrated in FIGS. 4, 5, and 7, one side of the beverage storage container 110 has the male connector 121 disposed near its bottom face, and the adjacent side face of the beverage storage container 110 has the female connector 122 disposed near its bottom face. This alternating pattern allows multiple storage containers 110 to connect to a single storage container 110 without having to flip a beverage storage container 110 upside down as shown in FIG. 9.

The cross container connectors 120 have a round, circular prism like structure. Each cross container connector 120 may have a lock member that is configured to engage with the lock member on a mating cross container connector 120 to prevent separation of the beverage storage containers 110 or the escape of beverage from the pressurized beverage storage containers 110. The lock members (e.g., spring biased snaps, twist locks, push-to-release, release by button, etc.) are configured to allow a user to operably connect and disconnect the beverages storage containers 110. To provide a secure connection, each connection point 123 may include sealing gaskets. The system's operation is further enhanced by the use of airtight sealing gaskets at each connection point 123, ensuring that no external air can enter the container network. This design maintains the quality of the beverage by preventing oxidation and contamination. Each beverage storage container's 110 pressure is managed within this sealed environment, ensuring that the beverage remains at its optimal condition throughout storage and dispensing.

The beverage storage containers 110 may or may not each include a dispenser 38. In some embodiments, the top face of the beverage storage container 110 includes a dispensing connector 130. The dispensing connector 130 is configured to connect with a cross container connector 120 and alternatively connect to an external dispenser and/or pressurized gas (e.g., a keg tap, CO2 bottle). The dispensing connector 130 is designed to be compatible with various dispensing systems, allowing it to attach to taps, kegerators, or other serving apparatus.

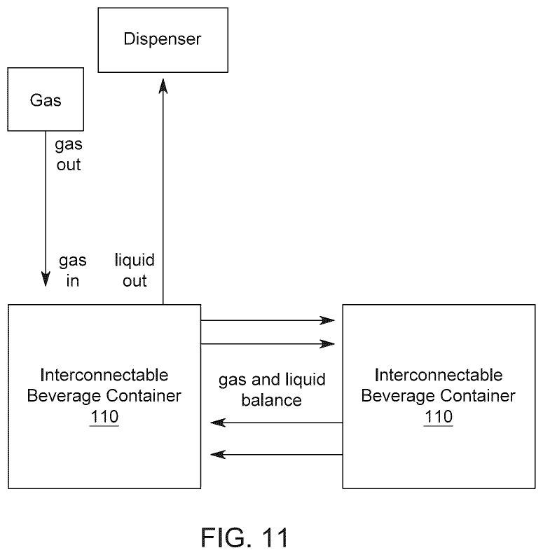

Referring to FIG. 11, The beverage storage and dispensing system 10 uses the connection from a single beverage storage container 110 to an external dispenser as the primary interface for beverage to exit from the system of multiple beverage storage containers 110. Likewise, a single connection from one beverage storage container 110 to an external pressurized gas tank (e.g., CO2 bottle) may be used to dispense the beverage from multiple beverage storage containers 110. In some embodiments, each beverage storage container 110 is a dual chamber storage container 110 and pressurized gas is sourced from an internal gas chamber 20. The sealed connection points 120 prevent air from entering the beverage storage system 10 and prevent pressurized gas from escaping, thus allowing a gas and dispenser connection at one storage container 110 to balance pressure across each storage container 110 in the system 10 and for beverage to be dispensed from multiple storage containers 110.

In some embodiments, the cross container connectors 120 include pickup tubes (e.g. spears 14) to draw beverage from the bottom of a beverage storage container 110 and transfer it to another connected beverage storage container 110 for dispensing. When a connection between two beverage storage containers 110 has two contact points 123, each of the storage containers 110 may have an approximate gas and liquid pressure balance as shown in the diagram in FIG. 11, which allows the liquid beverage to be drawn from both beverage storage containers 110 even when only one beverage storage container 110 is connected to an external dispenser. In an exemplary embodiment, the gas and liquid balance allows the beverage to flow from each beverage storage container 110 at a substantially similar rate (i.e. the two storage containers 110 maintain a similar beverage fill level with respect to each other as the beverage is dispensed). Variations across storage container 110 configurations and embodiments may cause less of an exact liquid and gas balance and result in one of the storage containers 110 emptying at a faster rate than another storage container 110.

In some circumstances, it may be desirable to have the ability to transfer beverage from one beverage storage container 110 to another. For example, one beverage storage container 110 may need to be emptied into another beverage storage container 110 so that the empty beverage storage container 110 can be removed from the beverage storage system 10 and sent off to be refilled. In some embodiments, two beverage storage containers 110 are connected at a single connection point 123 and one of the beverage storage containers 110 (i.e. the one to be emptied) is connected to a pressurized gas source. The pressurized gas source may be used to increase the head pressure in one beverage storage container 110 and cause liquid beverage to flow through the single connection point 123 into the other beverage storage container 110. Specifically, a bottom beverage storage container 110 may connect to a top beverage storage container 110 through the dispensing connector 130 of the bottom container 110, wherein the dispensing connector 130 only permits fluid to exit through spear 14. An external source of pressurized gas is connected a cross container connector 120 near the top portion of the beverage storage container 110. The external source of pressurized gas may then be used to increase the head pressure of the bottom beverage storage container 110 and cause liquid beverage to be forced through the spear 14 and out the dispensing connector 130 of the bottom beverage storage container 110. To improve the flow of beverage from the bottom beverage container 110, the dispensing connector 130 of the top beverage storage container 110 may be configured to selectively allow gas to escape as the top beverage container 110 is being filled by the bottom beverage container 110. The dispensing connector 130 of the top beverage storage container 110 may also be connected to an external dispenser so that as the beverage is dispensed, the bottom beverage container 110 is completely emptied before the top beverage container 110 is emptied.

In some embodiments, the beverage container 110 comprises an inner shell 112 and an outer shell 111. For example, the inner shell 112 structure is configured to be sealed and safely hold pressurized gas and liquid while the outer shell 111 is configured to protect the inner shell 112 structure. The outer shell 111 may additionally comprise carrying handles and connection/mating surfaces for stacking or nestling multiple beverage storage containers 110 with each other.

The values/ranges noted above detailed description are exemplary. In an embodiment, the values/ranges are up to 10 percent greater than or up to 10 percent less than the value described above. In another example embodiment, the values/ranges are up to 5 percent greater than or up to 5 percent less than the value described above.

Example embodiments have been provided so that this disclosure will be thorough, and to fully convey the scope to those who are skilled in the art. Numerous specific details are set forth such as examples of specific components, devices, and methods, to provide a thorough understanding of embodiments of this patent application. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Terms of degree such as “generally,” “substantially,” “approximately,” and “about” may be used herein when describing the relative positions, sizes, dimensions, or values of various elements, components, regions, layers and/or sections. These terms mean that such relative positions, sizes, dimensions, or values are within the defined range or comparison (e.g., equal or close to equal) with sufficient precision as would be understood by one of ordinary skill in the art in the context of the various elements, components, regions, layers and/or sections being described.

Numerous modifications may be made to the exemplary implementations described above. These and other implementations are within the scope of this application.

What is claimed is:

1. A beverage storage container comprising:
a beverage chamber;
a gas chamber disposed within the beverage chamber;
a dispenser; and
a selector,
wherein the selector is movable between three positions: (1) an off position wherein the dispenser, the gas chamber, and the beverage chamber are isolated from each other, (2) a purge position wherein the dispenser and the gas chamber are in fluid communication with each other and the beverage chamber is isolated from the dispenser and the gas chamber, and (3) a dispense position wherein the dispenser, the gas chamber, and the beverage chamber are each in fluid communication with each other.

2. The beverage storage container of claim 1, wherein the gas chamber comprises a regulator configured to restrict an outflow of gas from the gas chamber at a set pressure.

3. The beverage storage container of claim 2, wherein the set pressure is between 5-25 psi.

4. The beverage storage container of claim 1, wherein the selector includes a sliding valve.

5. The beverage storage container of claim 1, further comprising a blocker configured to prevent fluid communication, wherein the dispenser is disposed above the blocker in the off position.

6. The beverage storage container of claim 1, further comprising a spear configured to guide fluid to the dispenser, wherein the dispenser and spear are disposed in an offset relationship to one another when the selector is in the off position and the purge position.

7. The beverage storage container of claim 1, wherein the gas chamber is configured to store between 5-100 ounces of CO₂.

8. The beverage storage container of claim 1, wherein the gas chamber is configured to store between 10-100 grams of CO₂.

9. The beverage storage container of claim 1, wherein when the selector is in the dispense position, the selector is configured to allow gas to flow from the gas chamber and increase head pressure in the beverage chamber.

10. The beverage storage container of claim 1, wherein when the selector is in the purge position, the selector is configured to allow gas to flow from the gas chamber through the dispenser and out of the beverage storage container.

11. A beverage storage system comprising:
a first beverage storage container; and
a second beverage storage container,
wherein the first and second beverage storage containers each include:
a pressurized beverage chamber;
at least two cross container connectors; and
a dispensing outlet connector,
wherein:
the first and second beverage storage containers are configured to connect to each other,
one of the at least two cross container connectors of the first beverage storage container is fluid communication with one of the at least two cross container connectors of the second beverage storage container, and
the pressurized beverage chamber of the first beverage storage container is pressure balanced with the pressurized beverage chamber of the second beverage storage container when the first and second beverage storage containers are connected.

12. The beverage storage system of claim 11, further comprising an external dispenser, wherein the external dispenser is configured to dispense a liquid beverage from both the first beverage storage container and the second beverage storage container through the dispensing outlet connector of the first beverage storage container.

13. The beverage storage system of claim 11, wherein the at least two cross container connectors comprise a male connector and a female connector.

14. The beverage storage system of claim 13, wherein the male connector and the female connector are on a same side of the respective beverage storage container.

15. The beverage storage system of claim 14, wherein connection of the first beverage storage container and the second beverage storage container includes two connection points, wherein at the first connection point, the male connector of the first beverage storage container is in fluid communication with the female connector of the second beverage storage container and at the second connection point, the female connector of the first beverage storage container is in fluid communication with the male connector of the second beverage storage container.

16. The beverage storage system of claim 11, wherein the at least two cross container connectors each include a lock feature, wherein the lock feature is configured to engage with a corresponding lock feature of a cross container connector on another beverage storage container.

17. The beverage storage system of claim 11, wherein the at least two cross container connectors includes eight cross container connectors.

18. The beverage storage system of claim 17, further comprising a third beverage storage container, wherein any one of the beverage storage containers is configured to simultaneously connect to the other two beverage storage containers.

19. The beverage storage system of claim 18, further comprising a fourth and fifth beverage storage container, wherein any one of the beverage storage containers is configured to simultaneously connect to the other four beverage storage containers.

20. The beverage storage system of claim 11, wherein each beverage storage container further comprises a gas chamber disposed within the pressurized beverage chamber.

21. A beverage storage container comprising:
a beverage chamber;
a gas chamber disposed within the beverage chamber;
a dispenser; and
a selector,
wherein the selector is movable between two positions: (1) an off position wherein the dispenser, the gas chamber, and the beverage chamber are isolated from each other, and (2) a dispense position wherein the dispenser, the gas chamber, and the beverage chamber are each in fluid communication with each other.
